(19) United States
(12) Patent Application Publication
(10) Pub. No.: US 2005/0138171 A1
(43) Pub. Date: Jun. 23, 2005

(54) Logical network traffic filtering

(76) Inventor: Thomas M. Slaight, Beaverton, OR (US)

Correspondence Address: FISH & RICHARDSON, PC, 12390 EL CAMINO REAL, SAN DIEGO, CA, 92130-2081, US

(21) Appl. No.: 10/741,533

(22) Filed: Dec. 19, 2003

(51) Int. Cl. G06F 15/173; G06F 15/16

(52) U.S. Cl. 709/225; 709/229

(57) ABSTRACT

A segment of data is accepted from a host system, a portion of the segment identifying a broadcast domain. The portion is compared with an identifier for an excluded broadcast domain, and the segment is filtered from a network connection if the portion corresponds to the identifier.

### BACKGROUND

A communication network spanning over a moderate-sized geographic area is typically configured into a local area network (LAN), according to a standard (e.g., an IEEE 802 LAN standard) for exchanging data over a network of interconnected end stations. In one type of network, end stations communicate over a shared access medium. Multiple end stations can be connected to a shared access medium, e.g., in a bus topology or in a star topology. In the bus topology, signals sent by one end station propagate along a bus and are received by other end stations. In the star topology signals sent by one end station propagate to a central device, such as a hub. The hub broadcasts the signals to all of the other end stations (typically after regenerating the signals). The end stations that share an access medium are in a common “access domain.”

When two or more end stations in an access domain attempt to send a signal over the shared access medium close enough in time such that their frames overlap, a “collision” occurs. Collisions are resolved according to the LAN standard, such as Ethernet or Carrier Sense Multiple Access with Collision Detection (CSMA/CD).

### DESCRIPTION OF DRAWINGS

FIG. 1 is block diagram of a local area network having multiple broadcast domains.

FIGS. 2A-2B are block diagrams of a management end station.

FIG. 3 is a block diagram of a non-management end station.

FIG. 4 is a block diagram of a transmission filter.

### DESCRIPTION

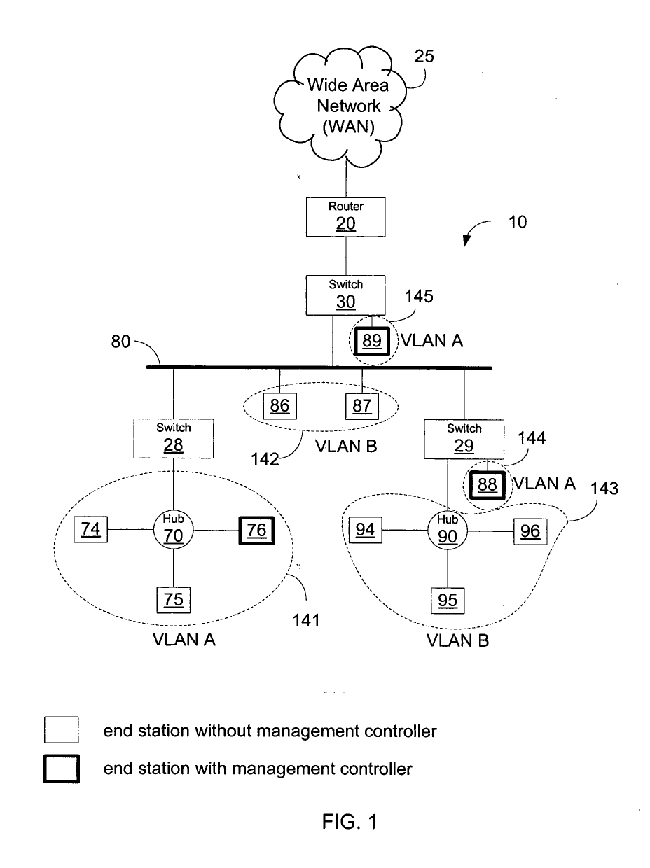

Referring to FIG. 1, a LAN 10 includes a VLAN-aware switch 28 that connects a hub 70 having end stations 74-76 (in an access domain 141) to a bus 80 having end stations 86-87 (in an access domain 142). A switch typically limits point-to-point traffic and forwards all broadcast and multicast traffic to a “broadcast domain” spanning all access domains in a LAN. To limit broadcast traffic to stay within portions of the LAN 10, the switch 28 uses a virtual LAN (VLAN) protocol (e.g., IEEE 802.1Q) to logically segment a LAN into separate (potentially overlapping) broadcast domains. This modified “VLAN-aware” switch 28 limits broadcast and multicast traffic to the access domains that include end stations assigned to a given VLAN (identified by a VLAN ID (VID)) and selected access domains along paths between the end stations. A VLAN-aware switch determines whether to forward a broadcast frame implicitly (e.g., based on the switch port that received the frame), or explicitly based on a VLAN ID (VID) included in a “tagged” frame.

The LAN 10 includes another VLAN-aware switch 29 that connects hub 90 having end stations 94-96 (in an access domain 143), and an end station 88, to the bus 80. A third VLAN-aware switch 30 connects the bus 80 to an end station 89 and a router 20 that connects the LAN 10 to a wide area network (WAN) 25. The router 20 exchanges traffic between the LAN 10 and the WAN 25 by examining the network address (e.g., an internet protocol (IP) address) in the frames that it receives.

The VLAN-aware switches 28-30 forward traffic according to a logical network arrangement of three VLANs. VLAN A includes end stations 74-76 in access domain 141, end station 88 (alone in its own access domain 144), and end station 89 (alone in its own access domain 145). VLAN B includes end stations 94-96 in access domain 143, and end stations 86-87 in access domain 142.

A management VLAN, VLAN_M, includes “management end stations” 76, 88, and 89, each of which includes a management controller.

In the LAN 10, the VLAN-aware switches 28-30 forward frames for VLAN M among the access domains 141, 142, 144, and 145. Even though the access domain 142 does not include a management end station, the switches forward frames with a VID corresponding to VLAN M (“management frames”) to this access domain 142 since it is on a path between management end stations. So in this network arrangement, non-management end stations 74, 75, 86, and 87 receive forwarded management frames. One way to increase efficiency by limiting the processing of management frames by the non-management end stations is to include an input filter to recognize management frames (e.g., by their VID) and prevent them from entering a protocol stack of a host computer system. The “protocol stack” receives and transmits data according to a set of networking protocols. The protocol stack is organized into layers (e.g., layers of the Open Systems Interconnection (OSI) model) that work together to perform functions such as segmenting data into data packets for transmission and reassembling received data packets. Data is encoded onto signals sent over the shared access medium in segments. A segment or “frame” includes a data packet and other protocol and address information.

A management end station may also use an input filter or switch to divert management frames from a host computer system in the management end station.

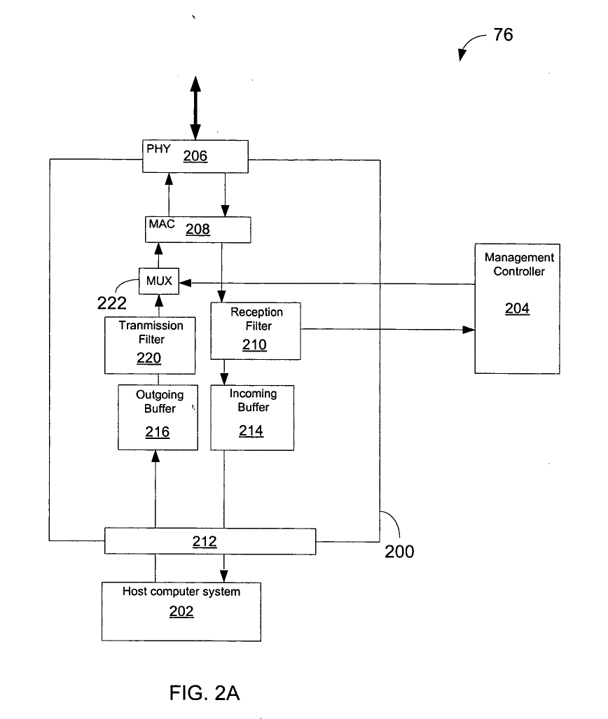

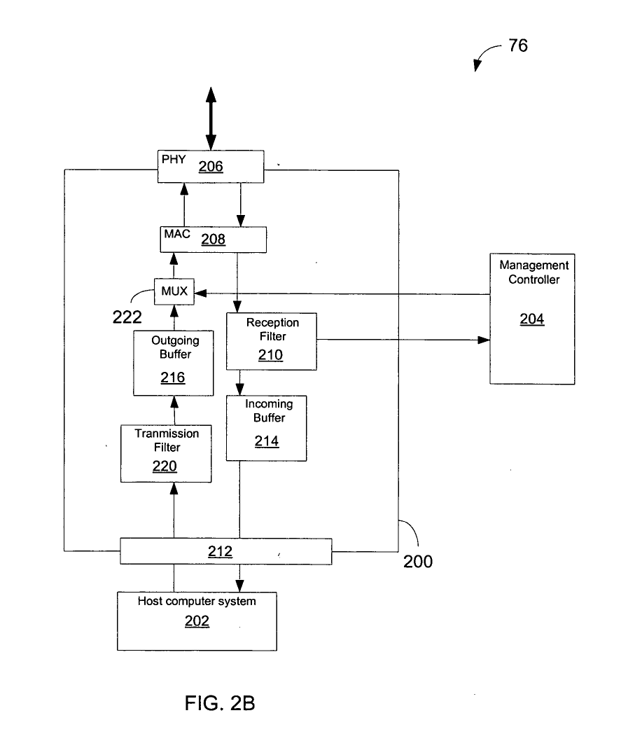

Referring to FIG. 2A, the management end station 76 includes a network controller 200 that shares a single physical layer (OSI layer 1) LAN interface 206 between an “in-band” protocol stack running on a host computer system 202, and “out-of-band” protocol stack running on a management controller 204. A medium access control (MAC) interface 208 handles the MAC layer (a sub-layer within OSI layer 2) functions for sending and receiving frames over the LAN interface 206. A received incoming frame is processed by an reception filter 210 that checks the VID of the incoming frame and sends the frame to the management controller 204 if the VID corresponds to VLAN M, sends the frame to the host computer system 202 if the VID corresponds to VLAN A (since end station 76 is a member of VLAN A), or discards the frame if the VID does not correspond to either VLAN M or VLAN A. If an incoming frame is “untagged” (i.e., does not include a VID) then the reception filter 210 can be optionally configured to send the frame to the in-band host computer system 202 or to discard the frame.

The data packets in the management frames are typically used for system platform management functions, such as providing remote power on/off, reset, and boot control functions, and providing access to platform health status (e.g., temperatures, voltages, fan state, etc. of the hardware elements) and platform alerting (e.g., sending messages indicating event information). The management controller 204 handles these functions using an out-of-band protocol stack so that processors of the host computer system 202 do not have to handle the management traffic.

The network controller 200 includes an interface 212 (e.g., a peripheral component interconnect (PCI) or peripheral component interconnect express (PCI-E) bus interface) to the host computer system 202 for sending and receiving in-band traffic. Frames that pass the reception filter 210 are temporarily stored in a first-in first-out (FIFO) buffer 214. The interface 212 sends frames to the host computer system 202 from the incoming buffer 214, and stores frames received from the host computer system 202 in an outgoing FIFO buffer 216. An outgoing frame stored in the outgoing buffer 216 has a VID corresponding to a destination VLAN for the frame. The multiplexer (MUX) 222 combines the in-band outgoing frames from the host computer system 202 and the out-of-band outgoing frames from the management controller 204 into a stream of outgoing frames passed to MAC interface 208 for transmission over the LAN.

Alternatively, the interface 212 is configured to handle the incoming and outgoing traffic at another protocol layer. For example, the data segments stored in the incoming 214 and outgoing 216 buffers can be data packets (e.g., corresponding to OSI layer 3). In this case, the reception filter 210 extracts the packet from the frame after checking the VID. The packets stored in the outgoing buffer are thus “tagged” packets that include a VID in the packet (e.g., designated bit locations in the header portion of the packet). The MAC interface 208 inserts this VID into the correct location in the frame, for example, in the Tag Control Information (TCI) portion of the frame for the IEEE 802.1Q VLAN protocol.

The network controller 200 may optionally be configured to assign a VID to an incoming frame based on a higher layer protocol. For example, the network controller can map particular ports or IP addresses to a VID.

A transmission filter 220 is included in the network controller 200 to prevent in-band traffic from the host computer system 202 from interfering with the operation of the management VLAN. For example, a host computer system on a management end station or a non-management end station could generate a denial-of-service attack or otherwise interfere with the management VLAN traffic. The reception filter 210 prevents the host computer system 202 from receiving management VLAN traffic, but does not prevent the host computer system 210 from sending frames with a VID corresponding to the VLAN M. The transmission filter 220 prevents propagation of malicious or inadvertently inserted traffic on the management VLAN by in-band software.

In the example of the management end station 76 shown in FIG. 2A, the transmission filter 220 is located between the outgoing buffer 216 and the MUX 222. The transmission filter 220 has a selection list that specifies one or more VID values for which to filter outgoing frames. For example, in the LAN 10, the transmission filter 220 filters VIDs for VLAN M and VLAN B from the frames sent by the host computer system 202 of end station 76 (since the host computer system 202 is a member only of VLAN A). Alternatively, the transmission filter 220 can be located in another portion of the network controller 200, as shown in another example of the management end station 76 in FIG. 2B, where the transmission filter is located before the outgoing buffer.

This approach to preventing host computer systems from interfering with management VLAN traffic (or other VLAN traffic) is particularly useful if all of the end stations in the LAN 10 incorporate transmission filters in their network controllers.

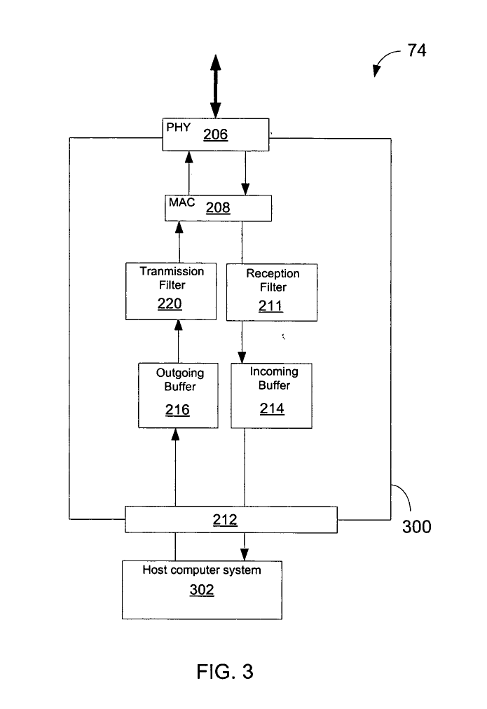

Referring to FIG. 3, a network controller 300 of a non-management end station 74 includes a transmission filter 220 that filters traffic from a host computer system 302. The network controller optionally includes a reception filter 211 as well, to provide more isolation of the host computer system 302 from the management traffic.

There are a variety of options for filtering frames belonging to a particular VLAN. In one approach the selection list includes VIDs for frames that are allowed to be transmitted by the host computer system 202, and for any VID that is not on the list, its corresponding frame is excluded from being transmitted by the host computer system 202. In another approach the selection list includes VIDS for excluded frames that are not allowed to be transmitted by the host computer system 202, and for any VID that is not on the list, its corresponding frame is allowed to be transmitted by the host computer system 202. In either case, the excluded frames are blocked or dropped as they come into or out of a network controller's outgoing buffer.

Alternatively, to simplify the processing of frames entering or leaving the buffer, the excluded frames may be intentionally corrupted so that the frames generate an error at a receiving end station causing the end station to discard the corrupted frames.

In one approach to corrupting a frame, the transmission filter 220 sets the VID to an unused or illegal value. A VLAN-aware switch between the source and destination end stations, or a filter in the destination end station will discard the unrecognized frame. In another approach, the transmission filter 220 changes one or more bits in the frame invalidating an appended Cyclical Redundancy Check (CRC). Typically, this CRC has been generated from an algorithm and is based on the data in the frame. If the frame is altered between the source and destination, the receiving station will recognize that the CRC no longer corresponds to the data in the frame and discard the frame.

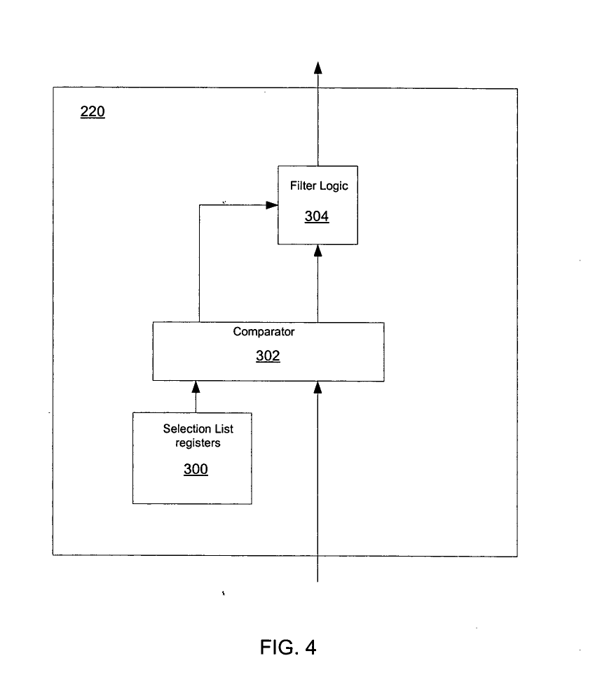

Referring to FIG. 4, an example of a transmission filter 220 includes a set of selection list registers 300 with values of excluded VIDs. A comparator 302 compares the VID portion of an incoming frame with each of the VIDs in the registers 300. Circuitry in the comparator performs these comparisons in parallel and performs a test to determine if any of the compared VIDs match. If there is a match found, the comparator 302 sends a signal to configure a filter logic module 304 to invert designated bits in a portion of the frame to intentionally corrupt the frame.

The transmission filter 220 is provided such that the transmission filter 220 is not configurable by the host computer system that is being filtered. One way to accomplish this in a management end station is to only allow the management controller access to selection list registers 300. Another way to accomplish this in either a management or non-management end station is to configure the selection list registers via a run-time inaccessible process such as an interface that gets locked by the Basic Input/Output System (BIOS) during a Power-On Self Test (POST) (e.g., the BIOS software sets a “lock bit” in the registers before turning control of the network controller over to the operating system of the host computer system).

Alternatively, a secured interface can be used to allow only an authorized user to configure the transmission filter 220, for example, by modifying the selection list registers 300 or indicating whether untagged frames are excluded or allowed. An authenticated interface can be integrated into software in the management controller 204 or the host computer system 202, or an authenticated interface can be built into the network controller hardware. For example, a designated port address or VID can enable a remote application to securely configure the selection list registers 300. Other types of security mechanisms can be used to prevent “in-band” software from defeating the transmission filtering.

The reception filters 210 and 211 are also optionally provided such that they are not configurable by the host computer system that is being filtered. A reception filter is configured in a similar way to the transmission filter 220 to prevent “in-band” software from defeating the reception filtering, for example, to intercept management frames.

Other embodiments are within the scope of the following claims.

1. A method comprising:
accepting a segment of data from a host system, a portion of the segment identifying a broadcast domain;
comparing the portion with an identifier for a selected broadcast domain; and
filtering the segment from a network connection based on the comparison.

2. The method of claim 1 wherein the host system comprises a computer system having a protocol stack configured to generate data packets.

3. The method of claim 2 wherein the segment of data comprises a frame including one of the data packets.

4. The method of claim 3 wherein the portion comprises a VLAN ID.

5. The method of claim 4 wherein the VLAN ID is configured according to an IEEE 802.1Q VLAN protocol.

6. The method of claim 4 further comprising generating the VLAN ID based on a network address.

7. The method of claim 1 wherein the segment is filtered from the network connection if the portion corresponds to the identifier.

8. The method of claim 1 wherein the segment is filtered from the network connection if the portion does not correspond to the identifier.

9. The method of claim 1 wherein the filtering comprises blocking the segment from being transmitted over the network connection.

10. The method of claim 1 wherein the filtering comprises intentionally corrupting the segment so that the segment is discarded from traffic received over the network connection.

11. The method of claim 1 wherein the identifier is inaccessible by the host system.

12. The method of claim 1 wherein the identifier is inaccessible by the host system after a boot phase.

13. The method of claim 1 wherein the segment is accepted from the host system over a data bus.

14. The method of claim 2 further comprising:
accepting a second segment of data from a physical layer network interface, a portion of the second segment identifying a broadcast domain;
comparing the portion of the second segment with an identifier for a broadcast domain associated with the host system; and
sending the second segment to the host system if the portion of the second segment corresponds to the identifier for the broadcast domain associated with the host system.

15. The method of claim 14 wherein the identifier for the broadcast domain associated with the host system is inaccessible by the host system.

16. The method of claim 14 wherein the identifier for the broadcast domain associated with the host system is inaccessible by the host system after a boot phase.

17. An apparatus comprising:
an interface to establish a network connection;
a network controller configured to
accept a segment of data from a host system, a portion of the segment identifying a broadcast domain;
compar the portion with an identifier for a selected broadcast domain; and
filter the segment from the network connection based on the comparison.

18. The apparatus of claim 17 wherein the host system comprises a computer system having a protocol stack configured to generate data packets.

19. The apparatus of claim 18 wherein the segment of data comprises a frame including one of the data packets.

20. The apparatus of claim 19 wherein the portion comprises a VLAN ID.

21. The apparatus of claim 17 wherein the segment is filtered from the network connection if the portion corresponds to the identifier.

22. The apparatus of claim 17 wherein the segment is filtered from the network connection if the portion does not correspond to the identifier.

23. The apparatus of claim 17 wherein the filtering comprises blocking the segment from being transmitted over the network connection.

24. The apparatus of claim 17 wherein the filtering comprises intentionally corrupting the segment so that the segment is discarded from traffic received over the network connection.

25. The apparatus of claim 17 wherein the identifier is inaccessible by the host system.

26. The apparatus of claim 17 wherein the identifier is inaccessible by the host system after a boot phase.

27. A system comprising:
a host system;
an interface to establish a network connection between a network and the host system; and
a network controller configured to
accept a segment of data from the host system, a portion of the segment identifying a broadcast domain;
compare the portion with an identifier for a selected broadcast domain; and
filter the segment from the network connection based on the comparison.

28. The system of claim 27 further comprising a management system having a protocol stack configured to generate management packets.

29. The system of claim 27 wherein the host system comprises a computer system having a protocol stack configured to generate data packets.

30. The system of claim 28 wherein the segment of data comprises a frame including one of the data packets.

31. The system of claim 29 wherein the portion comprises a VLAN ID.

32. The system of claim 27 wherein the segment is filtered from the network connection if the portion corresponds to the identifier.

33. The system of claim 27 wherein the segment is filtered from the network connection if the portion does not correspond to the identifier.

34. The system of claim 27 wherein the filtering comprises blocking the segment from being transmitted over the network connection.

35. The system of claim 27 wherein the filtering comprises intentionally corrupting the segment so that the segment is discarded from traffic received over the network connection.

36. The system of claim 27 wherein the identifier is inaccessible by the host system.

37. The system of claim 27 wherein the identifier is inaccessible by the host system after a boot phase.

38. A system comprising:
a router;
a host system;
an interface to establish a network connection between the router and the host system; and
a network controller configured to
accept a segment of data from the host system, a portion of the segment identifying a broadcast domain;
compare the portion with an identifier for a selected broadcast domain; and
filter the segment from the network connection based on the comparison.

39. The system of claim 38 wherein the portion comprises a VLAN ID.
